(19) United States
(12) Patent Application Publication
(10) Pub. No.: US 2009/0028657 A1
(43) Pub. Date: Jan. 29, 2009

(54) Machine Tool Having Linear Guide Device And Method For Exchanging Linear Guide

(76) Inventors: Shunichi Ishikawa, Aichi (JP); Masato Sugita, Aichi (JP); Kenji Matsushita, Aichi (JP); Takayoshi Torii, Aichi (JP); Koichi Sakal, Aichi (JP); Jiro Inoue, Aichi (JP); Tsutomu Sugihara, Toyama (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/792,480

(22) PCT Filed: Dec. 8, 2005
(86) PCT No.: PCT/JP05/23086

§ 371 Date: Apr. 21, 2008

(30) Foreign Application Priority Data
Dec. 9, 2004 (JP) 2004-357312

(51) Int. Cl. B23Q 1/01; B23Q 3/155

(52) U.S. Cl. 409/202; 483/1

(57) ABSTRACT

The purpose of the present invention is to propose a machine tool having a linear guide device with new construction enabling exchange of a linear guide by easy work.

With regard to a machine tool having linear guide devices 1 each of which has a base 11, guide rails 12 mounted on the base 11, linear guides 2 movably mounted on the guide rails 12, and jack-up mechanism comprising a saddle 9 (moving body) movably supported by the guide rails 12 through the linear guides and jack-up bolts 5 arranged between the base 11 and the saddle, the linear guides are fixed to the saddle through a fixing member, the fixation of the linear guides to the saddle is released by operating the fixing member, and gaps 8 are formed between the saddle and the linear guides by the jack-up mechanism arranged between the base and the saddle (moving body), whereby the linear guides can be exchanged.

### TECHNICAL FIELD OF THE INVENTION

The present invention relates to an art concerning a machine tool of a machining center or the like. In more detail, the present invention relates to an art of machine tool having a linear guide device for moving a moving body such as a saddle rectilinearly reciprocally along a guide rail.

### BACKGROUND ART

Conventionally, with regard to a machine tool of a machining center or the like, a linear guide device is provided on a moving body such as a saddle or a column. By the linear guide device, the moving body is moved rectilinearly reciprocally along a guide rail.

There are many literatures disclosing concrete construction of the linear guide device (for example, see the Japanese Patent Laid Open Gazette 2000-170761 or the Japanese Patent Laid Open Gazette 2003-56562).

As disclosed by these literatures, the linear guide device comprises the guide rail mounted on a base and a linear guide movably mounted on the guide rail. The linear guide is attached to the lower surface of the moving body.

With regard to the above-mentioned conventional construction of the linear guide device, the full load of the moving body is supported by the linear guide. Accordingly, large-scale work is required for exchanging the linear guide. For example, the heavy moving body is lifted up by a crane.

With regard to the construction that fixing bolts are inserted from the lower side of the linear guide so as to fix the linear guide to the lower surface of the moving body as disclosed by above-mentioned literatures, it is necessary to secure widely a clearance for pulling out the fixing bolts and a clearance for inserting tools, whereby the movement of lift-up is increased.

### SUMMARY OF THE INVENTION

In consideration of the above-mentioned problem, the present invention proposes a machine tool having a linear guide device with new construction enabling exchange of a linear guide by easy work.

According to the first invention of the present invention, with regard to a machine tool having a linear guide device comprising a base; a guide rail mounted on the base; a linear guide movably mounted on the guide rail; a moving body movably supported by the guide rail through the linear guide; and a jack-up mechanism mounted on the moving body, the linear guide is fixed to the moving body through a fixing member; fixation of the linear guide to the moving body is released by operating the fixing member; a gap is formed between the moving body and the linear guide by the jack-up mechanism arranged between the base and the moving body; and the linear guide can be exchanged.

Preferably, the fixing member is operated from upper side of the linear guide.

Preferably, a free space for operating the fixing member is made above an upper surface of the moving body.

Preferably, the jack-up mechanism is a jack-up bolt screwed vertically into the moving body, and a tip of the jack-up bolt touches a receiving part of the base so as to lift up the moving body.

According to the present invention, with regard to method for exchanging a linear guide of a machine tool that a moving body is supported through the linear guide by a guide rail mounted on a base, the moving body is lifted up by jack-up mechanism after releasing fixation of the linear guide to the moving body so that the linear guide can be detached from and attached to the moving body.

According to the first invention of the present invention, with regard to a machine tool having a linear guide device comprising a base; a guide rail mounted on the base; a linear guide movably mounted on the guide rail; a moving body movably supported by the guide rail through the linear guide; and a jack-up mechanism mounted on the moving body, the linear guide is fixed to the moving body through a fixing member; fixation of the linear guide to the moving body is released by operating the fixing member; a gap is formed between the moving body and the linear guide by the jack-up mechanism arranged between the base and the moving body; and the linear guide can be exchanged. Accordingly, compared with the conventional large-scale work using a crane, the man-hour and time for the work are reduced widely.

The fixing member is operated from upper side of the linear guide. Accordingly, even if the distance between the moving body and the base is short, the fixing bolts can be operated.

A free space for operating the fixing member is made above an upper surface of the moving body. Accordingly, a working space for operating the fixing member is secured.

The jack-up mechanism is a jack-up bolt screwed vertically into the moving body, and a tip of the jack-up bolt touches a receiving part of the base so as to lift up the moving body. Accordingly, the device is constructed simply and in lower cost. The jack-up operation can be performed by the easy operation such as the screwing of the jack-up bolts.

According to the present invention, with regard to method for exchanging a linear guide of a machine tool that a moving body is supported through the linear guide by a guide rail mounted on a base, the moving body is lifted up by jack-up mechanism after releasing fixation of the linear guide to the moving body so that the linear guide can be detached from and attached to the moving body. Accordingly, compared with the conventional large-scale work using a crane, the man-hour and time for the work are reduced widely.

### BRIEF DESCRIPTION OF THE DRAWINGS

FIG. 1 is a drawing of a machine tool having linear guide devices according to the present invention.

FIG. 2 is a plan view of the same.

FIG. 3 is a drawing of the construction of the linear guide device according to the present invention.

FIG. 4 is a detailed drawing of the linear guide device in jacked-up state.

FIG. 5 is a drawing of exchange of a linear guide in jacked-up state.

### BEST MODE FOR CARRYING OUT THE INVENTION

An embodiment of the present invention will be shown below according to accompanying drawings.

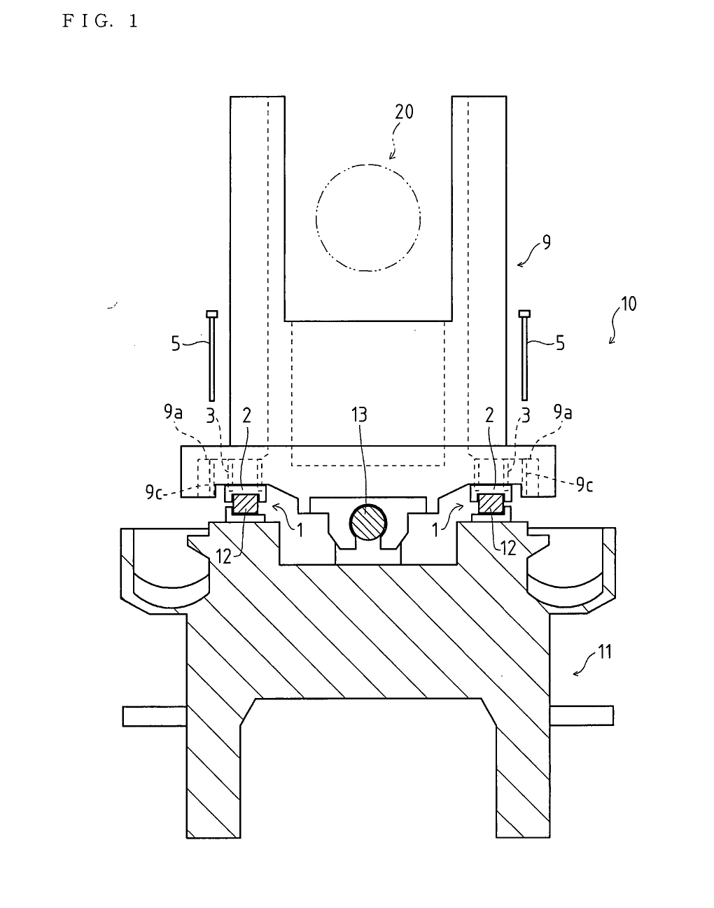

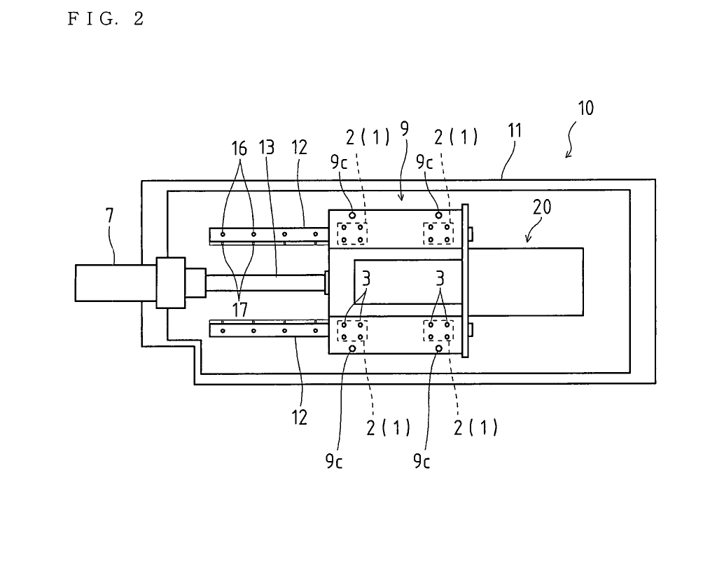

FIGS. 1 and 2 shows a machine tool 10 having linear guide devices 1 according to the present invention. Two guide rails 12 are mounted in parallel on an upper surface of a base 11 which is extended laterally in FIG. 2. A saddle 9 as a moving body is mounted on the guide rails 12 through linear guides 2. A spindle head 20 is attached to the saddle 9.

By rotation of a ball screw 13 rotated by a motor 7 (shown in FIG. 2), the saddle 9 is moved along the lateral direction in FIG. 2. The linear guides 2 are guided by the guide rails 12 so that the saddle 9 is moved rectilinearly.

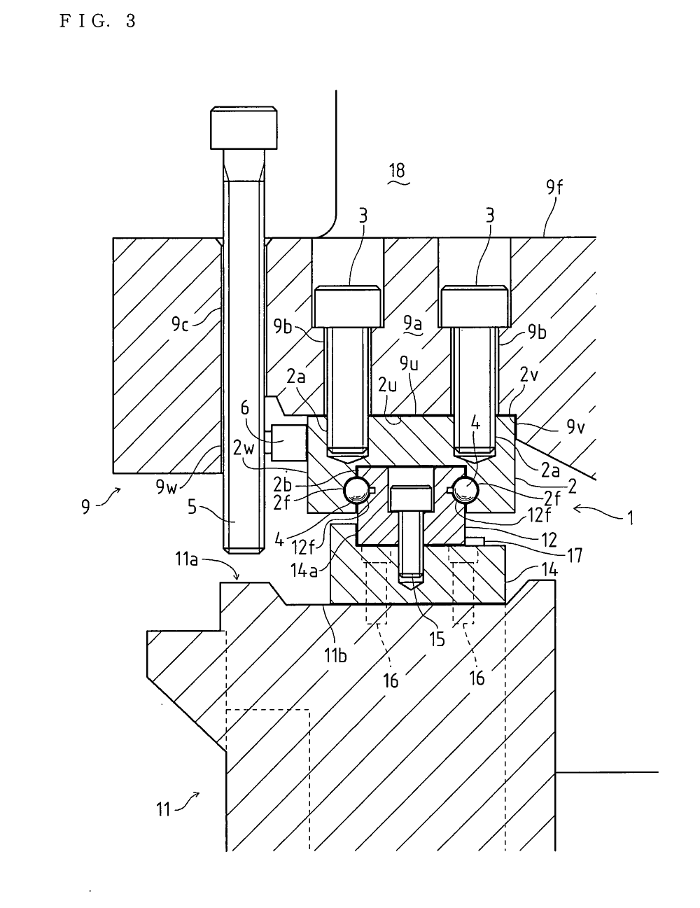

FIG. 3 shows the linear guide device 1 according to the present invention in detail. A guide rail mount 14 is mounted on and fixed to the base 11 with fixing bolts 16. The guide rails 12 are mounted on and fixed to the guide rail mount 14 with rail attaching bolts 15. The side surfaces of the guide rails 12 touch a reference surface 14a of the guide rail mount 14 and clamping pieces 17 are fixed to the guide rail mount 14 so that the position of the guide rails 12 in relation to the guide rail mount 14 is fixed.

As shown in FIG. 3, the part of the saddle 9 facing the upper surfaces of the guide rails 12 is constructed as a linear guide fixing part 9a. The part around an upper surface 9f of the linear guide fixing part 9a is a free space 18 so as to secure a space for operating guide attaching bolts 3 of the linear guides 2.

An upper surface 2u of each of the linear guides 2 touches a lower surface 9u of the linear guide fixing part 9a. A side surface 2v of the linear guide 2 is pushed by a push bolt 6 between a opposite side surface 2w and an inner wall surface 9w of the saddle 9 so that the side surface 2v touches a reference side surface 9v of the linear guide fixing part 9a.

As shown in FIG. 3, in section, each of the linear guides 2 is recessed to open rearward, and the guide rail 12 is inserted into this recessed part 2b.

A ball receiving hole 2f which is hemispheric is provided in each of left and right standing side surfaces of the recessed part 2b of each of the linear guides 2. A ball receiving hole 12f which is hemispheric is provided in each of left and right side surfaces of each of the guide rails 12. Balls 4 are received in these ball receiving holes 2f and 12f. By the rolling of the balls 4, the linear guides 2 are moved along the guide rails 12.

As shown in FIG. 3, through holes 9b are formed in the part of the linear guide fixing part 9a facing the free space 18. The guide attaching bolts 3 are inserted into the through holes 9b from the upper ends thereof (the ends opposite to the guide rails 12) and are screwed into bolt holes 2a of the linear guides 2.

Accordingly, the linear guides 2 are fixed to the linear guide fixing part 9a of the saddle 9 through the guide attaching bolts 3. The guide attaching bolts 3 can be operated easily from the upper side of the linear guides 2 (from the free space 18 at the side of the upper surface of the saddle 9).

In this embodiment, the guide attaching bolts 3 are inserted from the upper side of the linear guide fixing part 9a so as to fix the linear guides 2. However, guide attaching bolts may alternatively be inserted into the linear guides 2 from the lateral side (left side in the drawing) so as to be operated from the lateral side of the linear guides 2. With regard to the above-mentioned construction, any fixing member different from the guide attaching bolts 3 may alternatively be used. It is not limited to the form of bolt fixation.

As shown in FIG. 3, with regard to the saddle 9, bolt holes 9c (tapped holes) are provided penetratingly vertically in the linear guide fixing part 9a. A jack-up bolt 5 is screwed into each of the bolt hole 9c and the lower end of the jack-up bolt 5 is made to touch an upper surface of a receiving part 11a of the base 11 so as to lift the saddle 9 upward.

In this embodiment, the bolt holes 9c are provided penetratingly vertically in the part of the linear guide fixing part 9a at the side of the through holes 9b. As shown in FIG. 2, the bolt holes 9c are provided at plural positions corresponding to the linear guides 2.

With regard to the base 11, below the bolt holes 9c, the receiving part 11a is formed which is higher than a fixing surface 11b on which the guide rail mount 14 is mounted.

The saddle 9 is jacked up by the jack-up bolts 5 so as to exchange the linear guides 2.

Explanation will be given on the exchange work.

As shown in FIGS. 2, 4 and 5, the saddle 9 is moved suitably, and the rail attaching bolts 15 and the clamping pieces 17 of one of the guide rails 12 are removed. Then, the saddle 9 is moved to the position distant from the motor 7. The engagement between the ball screw 13 and the saddle 9 is released so as to enable the saddle 9 to be jacked up.

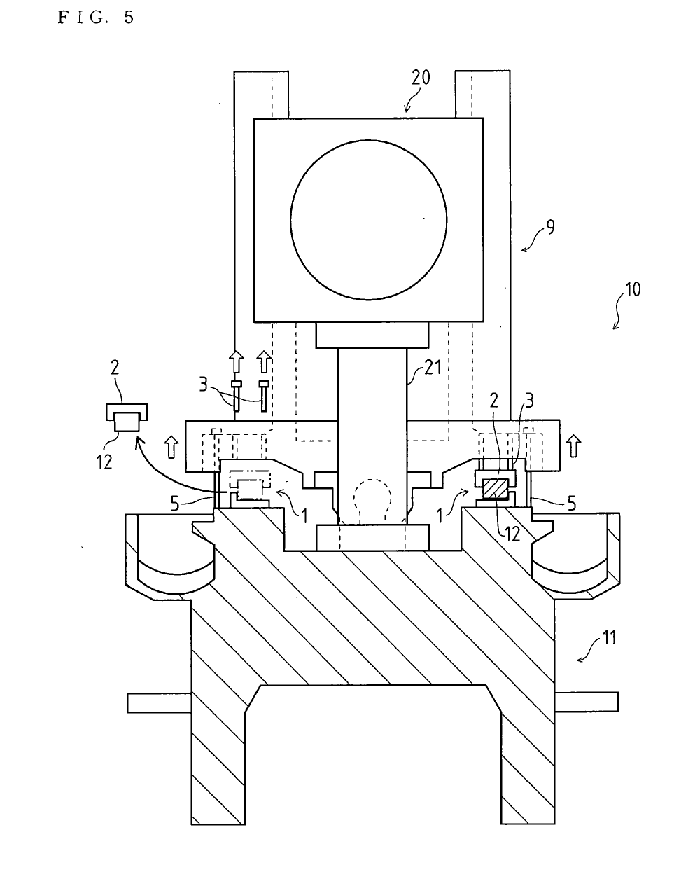

As shown in FIG. 5, a jack-mechanical bracket 21 is arranged between the spindle head 20 and the base 11 so as to support the weight of the spindle head 20 accessorily.

Next, the guide attaching bolts 3 of the linear guides 2 of the guide rail 12 to be exchanged are loosened and pulled out upward so as to release the fixation of the linear guides 2 to the linear guide fixing part 9a. The guide attaching bolts 3 of the linear guides 2 of the other guide rail 12 are not pulled out and only loosened so as to provide against jack-up. In addition, by releasing the fixation of the guide rail 12 beforehand similarly, the guide rail 12 and the linear guides 2 can be detached simultaneously.

With regard to each of the linear guides 2, the push bolt 6 is also loosened so as to prevent the twist between the push bolt 6 and the saddle 9.

Next, the jack-up bolt 5 is screwed into the bolt hole 9c downward so as to make the lower end of the jack-up bolt 5 touch the receiving part 11a, and then the jack-up bolt 5 is screwed further. The other jack-up bolts 5 arranged at the plural positions of the saddle 9 are screwed similarly, whereby the saddle 9 is supported by the plural jack-up bolts 5. At this time, the jack-mechanical bracket 21 also performs the jack-up.

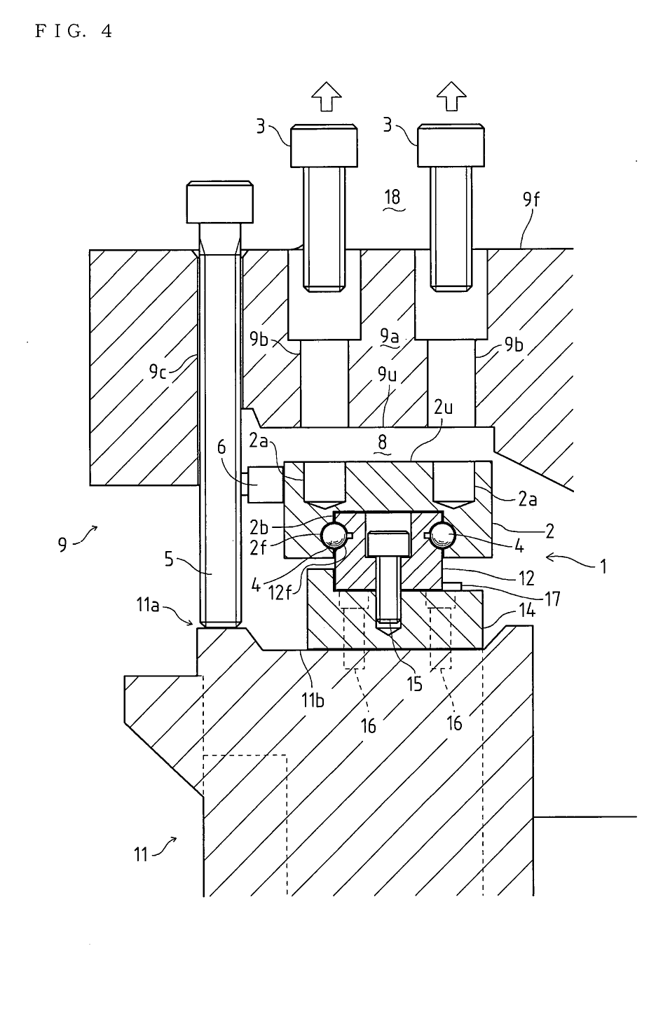

In this state, as shown in FIG. 4, a gap 8 is formed between the upper surface 2u of each of the linear guides 2 and the lower surface 9u of the linear guide fixing part 9a.

By forming the gap 8 as the above, the linear guides 2 and the guide rail 12 can be pulled out.

Then, after exchanging the linear guides 2 and the guide rail 12 of one of the sides, the linear guides 2 and the guide rail 12 of the other side are exchanged similarly.

As mentioned above, the guide attaching bolts 3 are loosened so as to release the fixation of the linear guides 2 to the linear guide fixing part 9a, and then the gaps 8 are formed by operating the jack-up bolts 5, whereby the linear guides 2 can be detached from the saddle 9 and the guide rail 12 can be detached from the base 11.

Then, the guide rail 12 to which new linear guides 2 have been set is attached to the base 11, and subsequently, the guide attaching bolts 3 and the push bolt 6 are adjusted while loosening the jack-up bolts 5, whereby the position of the linear guides 2 in relation to the linear guide fixing part 9a is fixed.

Accordingly, with regard to the method for exchanging the linear guides of the machine tool that the saddle 9 is supported through the linear guides 2 by the guide rails 12 mounted on the base 11, the fixation of the linear guides 2 to the saddle 9 is released, and then the saddle 9 is lifted up by the jack-up mechanism, whereby the linear guides 2 can be detached from and attached to the saddle 9.

As mentioned above, the guide attaching bolts 3 are operated from the upper side of the linear guides 2. Accordingly, even if the distance between the saddle 9 and the base 11 is short, the fixing bolts can be operated.

According to the present invention, with regard to the machine tool having the linear guide devices 1 each of which has the base 11, the guide rails 12 mounted on the base 11, the linear guides 2 movably mounted on the guide rails 12, and the jack-up mechanism comprising the saddle 9 (moving body) movably supported by the guide rails 12 through the linear guides 2 and the jack-up bolts 5 arranged between the base 11 and the saddle 9, the linear guides 2 are fixed to the saddle 9 through the fixing member comprising the guide attaching bolts 3, the fixation of the linear guides 2 to the saddle 9 is released by operating the fixing member, and the gaps 8 (see FIG. 4) are formed between the saddle 9 and the linear guides 2 by the jack-up mechanism arranged between the base 11 and the saddle 9 (moving body), whereby the linear guides 2 can be exchanged.

According to the construction, compared with the conventional large-scale work using a crane, the man-hour and time for the work are reduced widely.

The jack-up bolts 5 may have been inserted into the bolt holes 9c always, or may be inserted at need.

In this embodiment, the simple jack-up mechanism is constructed by the jack-up bolts 5 so as to reduce the cost of the device. The linear guides 2 can be exchanged by the easy operation such as the screwing of the jack-up bolts 5.

Instead of the above-mentioned jack-up bolts 5, jack-up mechanism may alternatively be constructed by a mechanical jack-up device that a rod is extended by rotation of gears or a hydraulic jack-up device.

### INDUSTRIAL APPLICABILITY

The present invention is applicable to a machine tool of a machining center or the like.

1. A machine tool having a linear guide device comprising:
a base;
a guide rail mounted on the base;
a linear guide movably mounted on the guide rail;
a moving body movably supported by the guide rail through the linear guide; and
a jack-up mechanism mounted on the moving body,
characterized in that:
the linear guide is fixed to the moving body through a fixing member;
fixation of the linear guide to the moving body is released by operating the fixing member;
a gap is formed between the moving body and the linear guide by the jack-up mechanism arranged between the base and the moving body; and
the linear guide can be exchanged.

2. The machine tool having the linear guide device as set forth in claim 1, wherein the fixing member is operated from upper side of the linear guide.

3. The machine tool having the linear guide device as set forth in claim 1, wherein a free space for operating the fixing member is made above an upper surface of the moving body.

4. The machine tool having the linear guide device as set forth in one of claims 1, wherein
the jack-up mechanism is a jack-up bolt screwed vertically into the moving body, and
a tip of the jack-up bolt touches a receiving part of the base so as to lift up the moving body.

5. Method for exchanging a linear guide of a machine tool that a moving body is supported through the linear guide by a guide rail mounted on a base, characterized in that:
after releasing fixation of the linear guide to the moving body, the moving body is lifted up by jack-up mechanism so that the linear guide can be detached from and attached to the moving body.
